(19) United States
(12) Patent Application Publication
(10) Pub. No.: US 2022/0110413 A1
(43) Pub. Date: Apr. 14, 2022

(54) METHODS FOR MANUFACTURING THREE-DIMENSIONAL FOOTWEAR PRODUCT AND THREE-DIMENSIONAL FOOTWEAR PRODUCT

(71) Applicant: LUXCREO (BEIJING) INC., Beijing (CN)

(72) Inventors: Hongyi CHE, Beijing (CN); Long ZHANG, Beijing (CN)

(73) Assignee: LUXCREO (BEIJING) INC., Beijing (CN)

(21) Appl. No.: 17/450,439

(22) Filed: Oct. 8, 2021

(30) Foreign Application Priority Data
Oct. 13, 2020 (CN) 202011088183.9

(51) Int. Cl. A43B 23/02; B33Y 10/00; B33Y 50/00; B33Y 80/00; B29C 64/386

(52) U.S. Cl. CPC A43B 23/0295; B33Y 10/00; B29L 2031/505; B33Y 80/00; B29C 64/386; B33Y 50/00

(57) ABSTRACT

A method for manufacturing a three-dimensional (3D) footwear product may be provided. The method may include obtaining foot feature data. The foot feature data may include a size of a foot. The method may also include constructing a planar model of the 3D footwear product based on the foot feature data. The planar model may include a body region and a connection structure connected to the body region. The method may further include printing a planar product of the 3D footwear product using a 3D printing method based on the planar model.

### CROSS-REFERENCE TO RELATED APPLICATIONS

This application claims priority to Chinese Application No. 202011088183.9, filed on Oct. 13, 2020, the entire contents of which are hereby incorporated by reference.

### TECHNICAL FIELD

The present disclosure relates to footwear products manufacturing field, and in particular, to a three-dimensional (3D) footwear product and a method for manufacturing the 3D footwear product.

### BACKGROUND

With the development of manufacturing technology, three-dimensional (3D) printing is widely used in the manufacture of footwear products. Compared with a traditional manufacturing technology, 3D printing can reduce the difficulty of manufacturing. However, the manufacturing of footwear products using 3D printing is still complicated. It is desirable to provide simpler and more efficient 3D printing methods for manufacturing footwear products.

### SUMMARY

According to an aspect of the present disclosure, a method for manufacturing a three-dimensional (3D) footwear product may be provided. The method may include obtaining foot feature data. The foot feature data may include a size of a foot. The method may also include constructing a planar model of the 3D footwear product based on the foot feature data. The planar model may include a body region and a connection structure connected to the body region. The method may further include printing a planar product of the 3D footwear product using a 3D printing method based on the planar model.

In some embodiments, the method may include bending the planar product according to a preset bending process. The method may further include connecting the connection structure according to a preset connection relationship.

In some embodiments, the method may include constructing a 3D model of the 3D footwear product based on the foot feature data. The method may further include determining the planar model based on the 3D model.

In some embodiments, the planar model may include a hollow region.

In some embodiments, the foot feature data may include at least a length of the foot or a width of the foot.

In some embodiments, the 3D printing method may include at least one of a stereolithography printing method, a fused deposition modeling printing method, or a laser sintering printing method.

In some embodiments, the 3D footwear product may be a shoe cover. The shoe cover may be used to fit with a preset shoe body to form a whole shoe, and the preset shoe body may be pre-made. The body region of the planar model of the shoe cover may include a vamp, a left quarter, and a right quarter, and the left quarter and the right quarter are both connected to a rear side of the vamp.

In some embodiments, the connection structure may include a first connector, a second connector, a third connector, and a fourth connector. The first connector may be connected to a left side of the vamp. The second connector may be connected to a right side of the vamp. The third connector may be connected to a left side of the left quarter. The fourth connector may be connected to a right side of the right quarter.

In some embodiments, the preset bending process may include bending down a region of the planar product corresponding to the left quarter, and a region of the planar product corresponding to the right quarter, relative to a region of the planar product corresponding to the vamp. The preset bending process may include bending down a left side of the region of the planar product corresponding to the vamp. The preset bending process may also include bending down a right side of the region of the planar product corresponding to the vamp. The preset bending process may also include bending a left side of the region of the planar product corresponding to the left quarter to the right. The preset bending process may further include bending a right side of the region of the planar product corresponding to the right quarter to the left. The preset connection relationship may include that the first connector is connected to the second connector, and the third connector is connected to the fourth connector.

In some embodiments, a connection process of at least one of the first connector, the second connector, the third connector, or the fourth connector may include at least one of buckling, bonding, or snapping.

In some embodiments, the 3D footwear product may include an upper. The connection structure may include a plurality of connecting holes. The plurality of connecting holes may be configured to be located on the upper. The upper may be configured to wrap a pre-made sole to form a whole shoe.

According to another aspect of the present disclosure, a three-dimensional (3D) footwear product may be provided. The 3D footwear product may be manufactured according to a process. The process may include obtaining foot feature data. The foot feature data may include a size of a foot. The process may also include constructing a planar model of the 3D footwear product based on the foot feature data. The planar model may include a body region, and a connection structure connected to the body region. The process may further include printing a planar product of the 3D footwear product using a 3D printing method based on the planar model.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a flowchart illustrating an exemplary process for manufacturing a 3D footwear product according to some embodiments of the present disclosure;

FIG. 2A and FIG. 2B are schematic diagrams illustrating exemplary foot feature data of a foot according to some embodiments of the present disclosure;

FIG. 3 is a schematic diagram illustrating an exemplary planar model of a shoe cover according to some embodiments of the present disclosure;

FIG. 4 is a schematic diagram illustrating an exemplary 3D model of a shoe cover according to some embodiments of the present disclosure;

FIG. 5 is a side view of an exemplary 3D model of a shoe cover according to some embodiments of the present disclosure;

FIG. 6 is an upward view of an exemplary 3D model of a shoe cover according to some embodiments of the present disclosure;

FIG. 7 is a schematic diagram illustrating an exemplary shoe cover according to some embodiments of the present disclosure;

FIG. 8 is a schematic diagram illustrating an exemplary upper of a shoe cover according to some embodiments of the present disclosure; and

FIG. 9 is a schematic diagram illustrating a whole shoe according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

A 3D printing method is widely used in various fields (e.g., footwear products manufacturing field). In some embodiments, a 3D footwear product may be printed using a 3D printing method such as a stereolithography printing method, a fused deposition modeling printing method, a laser sintering printing method, etc. However, a process of the printing of the 3D footwear product is complicated. For example, different footwear products have different shapes, and multiple parts of each footwear product may have curved arcs. If a whole 3D footwear product is print directly, a supporting component needs to be constructed on a model of the 3D footwear product. The supporting component is printed during the process of the printing of the whole 3D footwear product to support the 3D footwear product being formed. After the printing of the whole 3D footwear product is completed, the supporting component needs to be removed from the whole 3D footwear product, which is complicated.

An aspect of the present disclosure relates to a method for manufacturing a 3D footwear product. The method may include one or more of the following operations. Foot feature data may be obtained. The foot feature data may include a size of a foot. A planar model of the 3D footwear product may be constructed based on the foot feature data. The planar model may include a body region and a connection structure connected to the body region. A planar product of the 3D footwear product may be printed using a 3D printing method based on the planar model. The planar product may be assembled into the 3D footwear product. In this way, the 3D footwear product may be obtained based on the planar model, which avoids the construction of a supporting component model and the separation of the supporting component and the footwear product after the printing is completed, thereby simplifying the manufacturing process of the 3D footwear product, and reducing manufacturing difficulty.

In addition, the planar model of the 3D footwear product may be constructed based on foot feature data of a user, thereby realizing customization of the 3D footwear product based on the foot feature data of the user. The method for manufacturing a 3D footwear product of the present disclosure may be used to manufacture a shoe cover, an upper, a sole, a whole shoe, etc., of a 3D footwear product. It should be noted that the method for manufacturing a 3D footwear product of the present disclosure described below is merely provided as an example, and not intended to limit the scope of the present disclosure. The methods disclosed herein may be applied to manufacture any other products, such as handicrafts, daily necessities, etc.

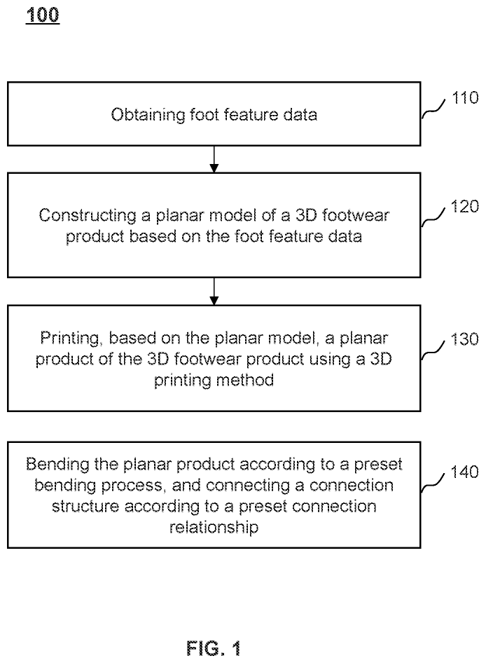

FIG. 1 is a flowchart illustrating an exemplary process for manufacturing a 3D footwear product according to some embodiments of the present disclosure. The operations of the illustrated process presented below are intended to be illustrative. In some embodiments, the process 100 may be accomplished with one or more additional operations not described, and/or without one or more of the operations discussed. Additionally, the order in which the operations of the process 100 as illustrated in FIG. 1 and described below is not intended to be limiting.

In 110, foot feature data may be obtained. The foot feature data may include at least a size of a foot.

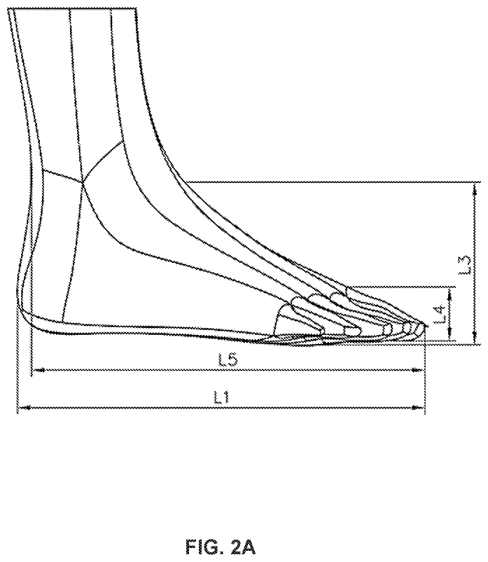

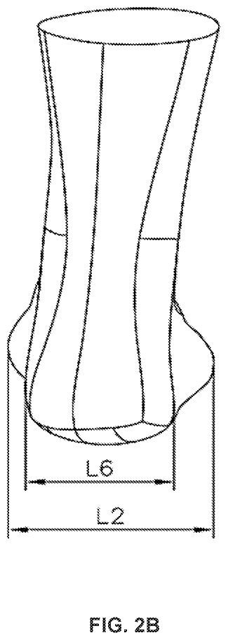

In some embodiments, the foot feature data may include a size of a foot corresponding to a 3D footwear product to be printed. A size of the 3D footwear product may be designed based on the foot feature data. For example, FIG. 2A and FIG. 2B are schematic diagrams illustrating exemplary foot feature data of a foot according to some embodiments of the present disclosure. As shown in FIG. 2A and FIG. 2B, the foot feature data of the foot may include at least a length L1 of the foot and a width L2 of the foot. The length L1 of the foot refers to a distance between the last end of the heel of the foot (i.e., the end of the heel away from the tiptoe) to the tiptoe of the foot (i.e., the tip of the longest toe). The width L2 of the foot refers to a maximum distance between the left side and the right side of the foot. A length and a width of the 3D footwear product may be designed based on the length of the foot and the width of the foot. In some embodiments, other foot feature data may be determined based on proportional relationships between values of other foot feature data (e.g., a height of the instep of the foot, a thickness of the thumb of the foot, etc.) and the length of the foot or the width of the foot. The proportional relationships may be default values stored in a database. The proportional relationships may be experience values determined by a user (e.g., an engineer). For example, if the 3D footwear product is a footwear product of an adult men, an average of heights of the insteps of adult male may be determined as the default value of the height of the instep of the foot corresponding to the 3D footwear product.

In some embodiments, as shown in FIG. 2A and FIG. 2B, the foot feature data may also include a height L3 of the instep, a thickness L4 of the thumb, a distance L5 of the most concave position of the heel and the tiptoe, and a width L6 of the heel. The height L3 of the instep refers to a maximum distance between the sole of the foot and the instep of the foot. The thickness L4 of the thumb refers to a maximum distance between the bottom of the thumb and the back of the thumb. The most concave position of the heel refers to a position of the heel closest to the ankle. The most concave position of the heel is roughly below the Achilles tendon. The distance L5 of the most concave position of the heel and the tiptoe refers to a distance between the most concave position of the heel and the tip of the longest toe. The width L6 of the heel refers to a distance between the left side and the right side of the heel. In some embodiments, the foot feature data may further include other information of the foot, e.g., a curvature of the heel, a length of each toe, a curvature of the instep. In some embodiments, the foot feature data may include a contour of the sole of the foot and/or a 3D contour of the foot. The contour of the sole of the foot may be represented as an image of the contour of the foot, which may indicate a shape and a size of the sole of the foot. The 3D contour of the foot may be represented as a 3D image of the contour of the entire foot, which may indicate a shape and a size of the entire foot. In some embodiments, the contour of the sole of the foot and/or the 3D contour of the foot may be acquired by a photographing device, a scanning device, etc. For example, the contour of the sole of a user may be acquired by scanning the sole of the foot of the user.

In some embodiments, the foot feature data of a user may be acquired by measuring the foot of the user. In some embodiments, the size (e.g., the length of the foot, the width of the foot, etc.) of the user may be manually measured using a measurement tool, and the measured foot feature data may be manually input into a processing device (e.g., a computer for constructing a planar model or a 3D model). Exemplary measurement tools may include a tape measure, a vernier caliper, or the like. In some embodiments, the size of the foot of the user, the contour of the heel, and/or the 3D contour of the foot may be measured by a measuring device. The measuring device may send measurement data to a processing device (e.g., a computer for constructing a planar model or a 3D model) (e.g., via a network). Specifically, the measuring device may capture or scan the foot of the user to obtain a 2D image and/or a 3D image of the foot of the user. The contour of the heel and/or the 3D contour of the foot may be obtained based on the 2D image and/or the 3D image of the foot of the user. In some embodiments, the measuring device may determine the size of the foot of the user based on the 2D image and/or the 3D image of the foot of the user. Alternatively, the measuring device may send the 2D image and/or the 3D image of the foot of the user to a processing device. The processing device may determine the size of the foot of the user based on the received 2D image and/or the 3D image of the foot of the user. In some embodiments, the measuring device may include a photographing device, a scanning device, or the like. Exemplary photographing devices may include a digital camera, an infrared camera, a low-light camera, a thermal imaging camera, or other device that can be used for visual records. Exemplary scanning devices may include a 3D scanner (e.g., a laser scanner, a 3D phase scanner, etc.), an ultrasound imaging device, or the like.

Multiple parts of the 3D footwear product may be designed based on the foot feature data, which may make the manufactured footwear product fit the shape of the foot of the user to improve the wearing comfort of the 3D footwear product. For example, for a user with a high instep, if a footwear product is designed and manufactured only based on the length and the width of the foot of the user, and other size of the footwear products is designed and manufactured based on a default value of the foot feature data (e.g., an average height of instep of adult male is used as a height of the instep of the user), the height of the instep of the user may not match the size of the manufactured 3D footwear product. When the user wears the footwear product, the user may feel uncomfortable because the footwear product squeezes the foot of the user (e.g., the instep of the user).

In 120, a planar model of the 3D footwear product may be constructed based on the foot feature data.

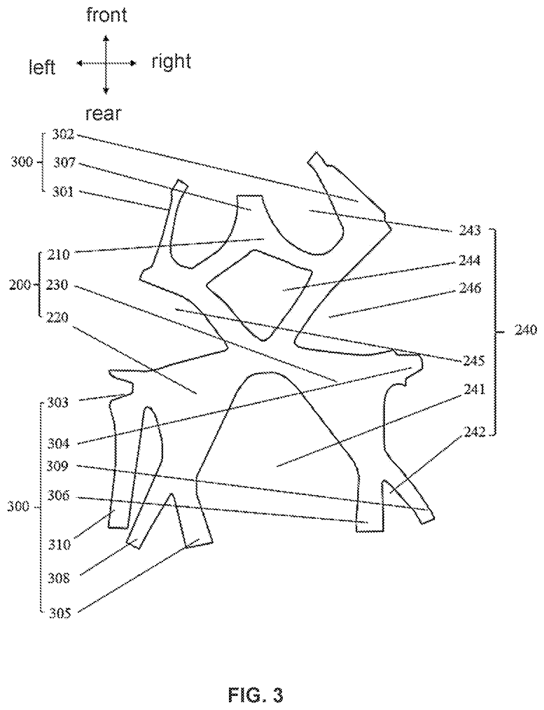

FIG. 3 is a schematic diagram illustrating an exemplary planar model of a shoe cover according to some embodiments of the present disclosure. As shown in FIG. 3, the planar model may include a body region 200 and a connection structure 300 connected to the body region 200. The body region 200 may be configured to form a surface of the 3D footwear product after printing. The connection structure 300 may be configured to connect multiple parts of the surface (e.g., a planar product) of the 3D footwear product after printing, to realize the assembly of the 3D footwear product.

In some embodiments, the planar model may be directly constructed based on the foot feature data. For example, the planar model may be constructed based on the foot feature data by a designer using a modeling software. In some embodiments, the planar model may be automatically generated by a computer device based on the foot feature data according to related algorithms stored in the computer device. Alternatively, after the computer device automatically generates an initial planar model, the designer may further adjust the initial planar model to construct the planar model.

In some embodiments, a 3D model of the 3D footwear product may be constructed based on the foot feature data. The planar model may be determined based on the 3D model. The 3D model may be manually constructed by a designer based on the foot-based data using a modeling software. Alternatively, the 3D model may be automatically generated by a computer device based on related algorithms stored in the computer device. Alternatively, after the computer device automatically generates an initial 3D model, the designer may further adjust the initial 3D model to construct the 3D model. Merely by way of example, after the foot feature data (e.g., the length of the foot and the width of the foot) is obtained, the designer may draw a 3D model of the foot of the user based on a proportion of foot feature data in the modeling software, and then draw the 3D model of the 3D footwear product based on the 3D model of the foot. Alternatively, after data of the 3D contour of the foot is obtained, the designer may directly draw the 3D model of the 3D footwear product based on the data of the 3D contour of the foot. Alternatively, after the computer device receives the foot feature data, the computer device may automatically construct the 3D model of the 3D footwear product based on the related algorithms stored in the computer device. Exemplary modeling software may include Rhino, SolidWorks, Catia, UG, etc.

In some embodiments, sizes of multiple parts of the planar model may be determined based on the 3D model. In some embodiments, image data of the planar model may be obtained by performing a flattening operation on the 3D model.

In some embodiments, a plurality of planar models (or 3D models) of 3D footwear products corresponding to different foot feature data may be stored in a database. When foot feature data of a user is obtained, a planar model (or a 3D model) of a 3D footwear product matched with the shape of the foot of the user may be obtained from the plurality of planar models (or 3D models) in the database. For example, a length of the foot may be divided into multiple ranges, and each range may correspond to a planar model (or a 3D model), and a corresponding planar model (or a corresponding 3D model) may be selected based on the length of the foot of the user.

In some embodiments, the planar model may include a hollow region 240. The hollow region 240 may correspond to a curved region of the 3D footwear product. By setting the hollow region 240, it is possible to avoid wrinkles in a region of the planar model corresponding to the curved region of 3D footwear product, so that the planar model can be printed as planar product easily. Moreover, the hollow region 240 may meet an air permeable demand and a shape design requirement of the 3D footwear product. In addition, by setting the hollow region 240, it is possible to reduce the material of the 3D footwear product and the time consumed by the printing process. In the process of determining image data of the planar model based on image data of the 3D model (e.g., in the process of flattening a 3D model to obtain a plane model), the hollow region 240 may correspond to a curved region of the 3D footwear product, so that the planar model determined based on the 3D model is flat. That is, when the planar model is folded or assembled into the 3D footwear product, the hollow region 240 on the planar model may correspond to the curved region of the 3D model (e.g., the tiptoe region, the heel region, etc.). In some embodiments, the planar model may be continuous and uninterrupted, that is, the planar model does not include the hollow region 240.

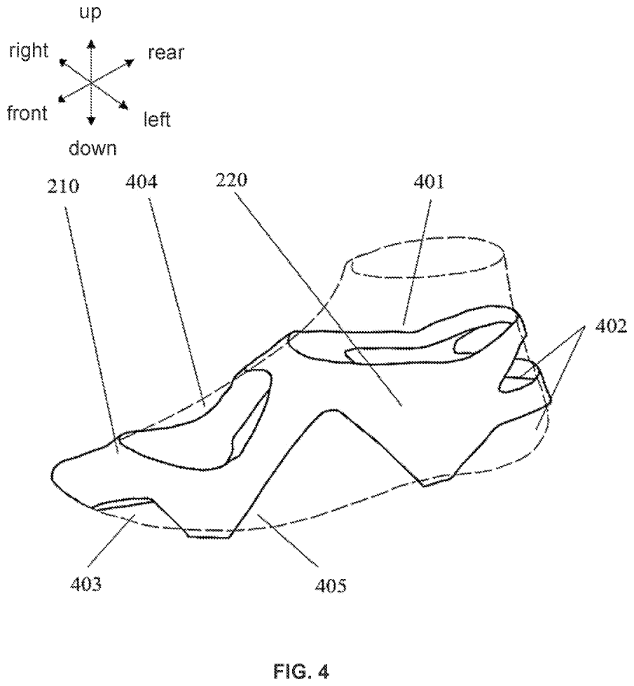

In some embodiments, as shown in FIG. 4, the hollow region 240 may correspond to a topline region 401, a heelpiece region 402, a toe cap region 403, a region corresponding to an instep 404, a region corresponding to a thumb, a region 405 corresponding to a little finger, of the 3D footwear product, or the like, or any combination thereof. In some embodiments, the hollow region 240 may correspond to other regions of the 3D footwear product, such as, an ankle region, a region corresponding to the sole of the foot. The hollow region 240 corresponding to the curved region of the 3D footwear product may be designed on the planar model, so that the planar model determined based on the 3D model is flat, which may be convenient for subsequent printing. A position, a shape, and a size of the hollow region 240 may be designed by a designer according to features of the 3D footwear product. For example, the shape of the hollow region 240 may adapted to the shape of the corresponding curved region. For example, for a curved region with a relatively large curvature, an area of the corresponding hollow region 240 may be relatively large.

In 130, a planar product of the 3D footwear product may be printed based on the planar model using a 3D printing method.

In some embodiments, size data of the planar model may be sent to a 3D printing device or a processing software of the 3D printing device to implement 3D printing. In some embodiments, image data of the planar model may be sent to the 3D printing device or the processing software of the 3D printing device to implement 3D printing.

The 3D printing method may include a stereolithography printing method, a fused deposition modeling printing method, a laser sintering printing method, or the like. Material for the 3D printing may include a bondable material such as a powder metal or resin. In some embodiments, the 3D printing device may include a stereolithography 3D printer, a fused deposition modeling 3D printer, a laser sintering 3D printer, or the like. The processing software of the 3D printing device may include Cura, EasyPrint 3D, SLIC3R, NetFabb Basic, etc.

In some embodiments, the 3D printing method may be the stereolithography printing method. The stereolithography printing method has the advantages of fast printing speed and high printing accuracy. The printing material for the stereolithography printing method may include resin material. The resin material may be flexible and elastic, which may make the planar product easy to bend, and can meet elasticity requirements of the footwear product.

Merely by way of example, the planar product of the 3D footwear product may be printed using the stereolithography printing method. The processing software (e.g., Cura, EasyPrint 3D, SLIC3R, NETFABB BASIC, etc.) of the 3D printer may divide the planar model of the 3D footwear product with a certain thickness into a plurality of cured layers along a thickness direction, and then a stereolithography printer may sequentially expose the plurality of cured layers. The thickness of each cured layer may be the same or different. For example, the planar model may be divided into a first cured layer, a second cured layer, and a third cured layer. The stereolithography printer may sequentially expose the first cured layer, the second cured layer, and the third cured layer. The first cured layer may be formed on a forming table of the printer, the second cured layer may be formed on the formed first cured layer, and the third cured layer may be formed on the formed second cured layer. The thickness of the first cured layer, the thickness of the second cured layer, and the thickness of the third cured layer may be the same, partially the same, or different. For example, the thickness of the first cured layer may be 1.5 mm, the thickness of the second cured layer may be 1.0 mm, and the thickness of the third cured layer may be 0.5 mm. Alternatively, the thickness of the first cured layer, the thickness of the second cured layer, and the thickness of the third cured layer may both be 1.0 mm. In some embodiments, cured regions of the first cured layer, the second curable layer, and the third cured layer may be sequentially reduced, so that the surface of the planar product is uneven, and the 3D footwear product may have textures to meet customized requirements of the user for textures.

In 140, the planar product may be bended according to a preset bending process, and the connection structure may be connected according to a preset connection relationship.

In some embodiments, after the planar product of the 3D footwear product is obtained, the planar product may be bended according to the preset bending process, and the connection structure of the planar product may be connected according to the preset connection relationship, to assemble the planar product into the 3D footwear product. The preset bending process and the preset connection relationship may be determined according to the structure of the planar product and the type of 3D footwear product. In some embodiments, operation 140 may be performed during the manufacturing of the 3D footwear product. In some embodiments, operation 140 may be performed by the user when the user uses the 3D footwear product. The planar product may be assembled into the 3D footwear product when the user uses the 3D footwear product, which may facilitate to store and carry the 3D footwear product.

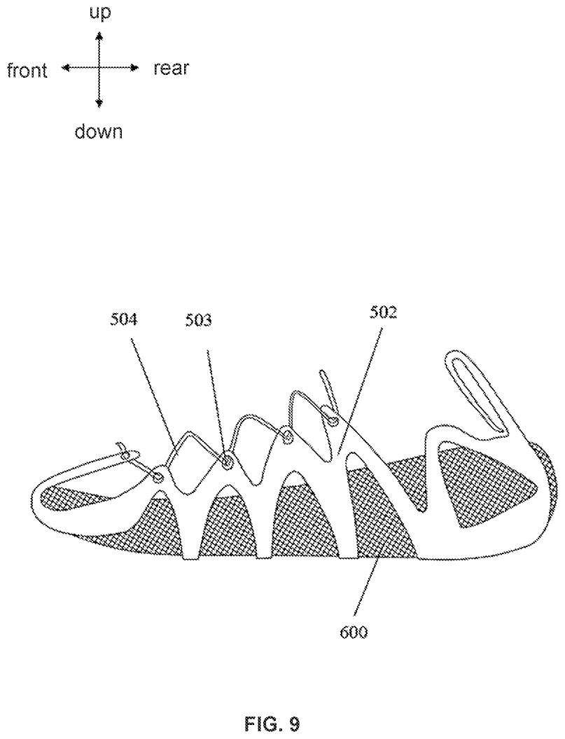

In some embodiments, the connection of the connection structure may include buckling, bonding, snapping, or the like. For example, the connection structure may include two connectors. A button may be configured on one connector, a buttonhole may be configured on the other connector, and the two connectors may be buckled together. As another example, the two connectors may be bonded together by an adhesive or a hot melt method. As still another example, a raised part may be configured on one connector, and a groove may be configured on the other connector. The raised part may be placed in the groove to achieve the snapping of the two connectors. Alternatively, after the raised part is placed in the groove, the two connectors may be bonded by the adhesive to make the connection of the two connectors more secure. In some embodiments, the connection structure may include a plurality of connectors, and the plurality of connectors may be connected via a rope or a tape 504, as shown in FIG. 9. For example, a rope may be provided on each of the plurality of connectors. The plurality of connectors may be connected by tying the ropes of the plurality of connectors. As another example, at least one connecting hole may be provided on each of the plurality of connectors. The plurality of connectors may be connected by passing the rope through the at least one connecting hole provided on each of the plurality of connectors.

In some embodiments, the connection mode of the connection structure may include a thermally curing connection. When the planar product of the 3D footwear product is printed using the stereolithography printing method, the printing material may include a dual-cured resin. By using the dual-cured resin, after the planar product is obtained after light curing molding (i.e., printing), the planar product may be bent according to the preset bending process, the connection structure of the planar product may be connected (e.g., a preliminary physical connection by overlapping or snapping), and the bent and connected planar product may be thermally cured to obtain the 3D footwear product. Specifically, the thermal curing may be achieved by heating. In this case, the plane product obtained by light curing the plane model of the 3D footwear product may include an uncured thermal curing component (i.e., the dual-cured resin). The connection structure of the plane product may be preliminarily physically connected (e.g., by overlapping or snapping) according to the preset connection relationship. Since the uncured thermal curing component (i.e., the dual-cured resin) is sticky, the connection structure may further be bonded via the uncured thermal curing component. During the thermal curing process, the uncured thermal curing component may be cured to further connect the connection structure. In the process of stereolithography printing using the dual-cured resin, it may be difficult to achieve a stable connection of the connection structure if only physical connections (e.g., overlapping or snapping) are used. After the preliminary physical connection of the connection structure, the thermal curing connection of the connection structure may make the connection of the connection structure more stable. In addition, by completing the connection of the connection structure during the thermal curing process, it is possible to eliminate the need for adhesive bonding, which may make the 3D footwear product more environmentally friendly.

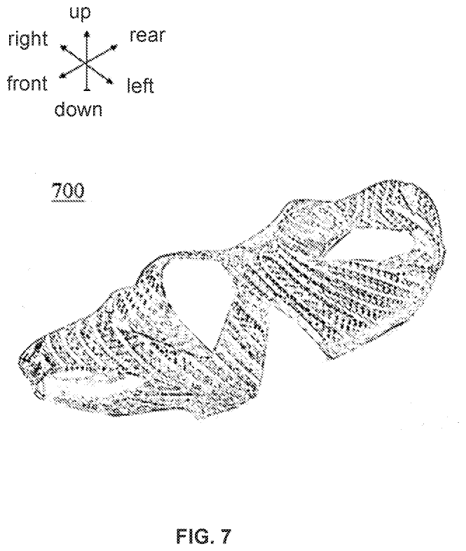

In some embodiments, the 3D footwear product may be a shoe cover. FIG. 7 is a schematic diagram illustrating an exemplary shoe cover 700 according to some embodiments of the present disclosure. The shoe cover 700 may be used to fit with a preset shoe body to form a whole shoe. The preset shoe body may be pre-made. In some embodiments, the preset shoe body may be manufactured by the 3D printing. For example, the preset shoe body may include an upper and a sole. The shoe cover 700 may be set over the upper and the sole to fix the upper and the sole to obtain a whole shoe. In some embodiments, the upper and/or the sole may be fixed to the shoe cover by stitching, bonding, etc. In some embodiments, the upper and the sole may be connected using an adhesive. The use of the shoe cover may reduce the use of the adhesive, which is more environmentally friendly. Moreover, the shoes made by the shoe cover 700 may be dismantled. Accordingly, when the upper or the sole is damaged, only the damaged portion needs to be replaced.

In some embodiments, as shown in FIG. 3, the body region 200 of the planar model of the shoe cover 700 may include a vamp 210, a left quarter 220, and a right quarter 230. The left quarter 220 and the right quarter 230 may both be connected to a rear side of the vamp 210. The vamp 210 of the shoe cover 700 may substantially correspond to the instep of the foot. The left quarter 220 may substantially correspond to the left side of the foot. The right quarter 230 may substantially correspond to the right side of the foot.

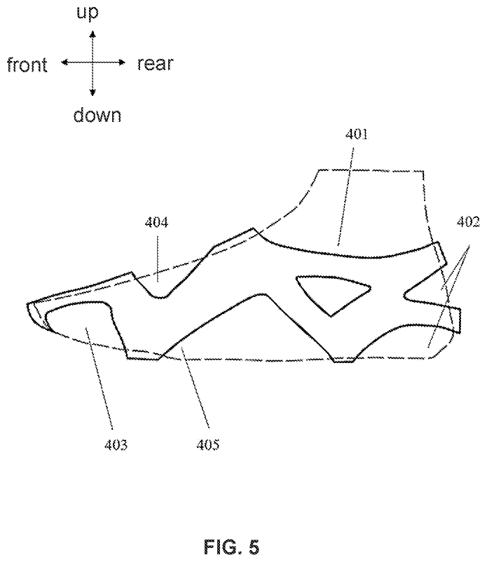

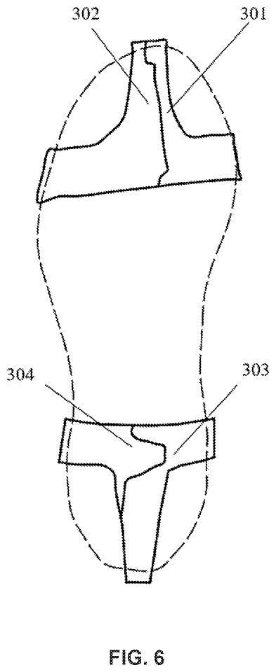

FIG. 4 is a schematic diagram illustrating an exemplary 3D model of a shoe cover according to some embodiments of the present disclosure. FIG. 5 is a side view of an exemplary 3D model of a shoe cover according to some embodiments of the present disclosure. FIG. 6 is an upward view of an exemplary 3D model of a shoe cover according to some embodiments of the present disclosure. As shown in FIGS. 3-5, the hollow region 240 may include a first hollow portion 241 provided in the topline region 401, a second hollow portion 242 provided in the heelpiece region 402, a third hollow portion 243 provided in the toe cap region 403, a fourth hollow portion 244 provided in the region corresponding to the instep 404 in the forefoot upper, a fifth hollow portion 245 provided in the region corresponding to the thumb in the forefoot upper, and a sixth hollow portion 246 provided in the region 405 corresponding to the little finger in the forefoot upper.

As shown in FIG. 3 and FIG. 6, the connection structure 300 may include a first connector 301, a second connector 302, a third connector 303, and a fourth connector 304. The first connector 301 may be connected to a left side of the vamp 210. The second connector 302 may be connected to a right side of the vamp 210. The third connector 303 may be connected to a left side of the left quarter 220. The fourth connector 304 may be connected to a right side of the right quarter 230. In some embodiments, the preset bending process may include following operations. A region of the planar product corresponding to the left quarter 220 and a region of the planar product corresponding to the right quarter 230 may be bent down relative to a region of the planar product corresponding to the vamp 210, to roughly form a shape of a shoe. A left side of the region of the planar product corresponding to the vamp 210 may be bent down. A right side of the region of the planar product corresponding to the vamp 210 may be bent down. A left side of the region of the planar product corresponding to the left quarter 220 may be may be bent to the right. A right side of the region of the planar product corresponding to the right quarter 230 may be bent to the left. The preset connection relationship may include that the first connector 301 is connected to the second connector 302, and the third connector 303 is connected to the fourth connector 304. The first connector 301 and the second connector 302 may be connected at the bottom of the forefoot of the foot, and the third connector 303 and the fourth connector 304 may be connected at the bottom of the backfoot of the foot. By setting the first connector 301, the second connector 302, the third connector 303, and the fourth connector 304, bending the planar product according to the preset bending method, and connecting the connection structure according to the preset connection relationship, the planar product may be assembled into the shoe cover 700 easily and conveniently, and the structure of the shoe cover 700 may be stable.

In some embodiments, the connection structure 300 may include a fifth connector 305 and a sixth connector 306. The fifth connector 305 may be connected to a rear side of the left quarter 220. The sixth connector 306 may be connected to a rear side of the right quarter 230. The preset bending process may include following operations. A rear side (of the region) of the planar product corresponding to the left quarter 220 may be bent to the right. A rear side (of the region) of the planar product corresponding to the right quarter 230 may be bent to the left. The preset connection relationship may include that the fifth connector 305 and the sixth connector 306 are connected. The fifth connector 305 and the sixth connector 306 may be connected at a region corresponding to the heel of the foot. By setting the fifth connector 305 and the sixth connector 306, and connecting the connection structure according to the preset connection relationship, the shoe cover 700 may fit with the preset shoe body at the region corresponding to the heel of the foot, so that the upper and the sole may be firmly fixed.

In some embodiments, the connection structure 300 may include a seventh connector 307. The seventh connection 307 may be connected to a front side of the vamp 210. The seventh connection 307 may be located between the first connector 301 and the second connector 302. The preset bending process may include following operation. A front side of the region of the planar product corresponding to the vamp 210 may be bent down. The preset connection relationship may include that the seventh connector 307 is connected to the first connector 301 and the second connector 302. By setting the seventh connector 307, the region of the planar product corresponding to the vamp 210 may wrap the tiptoe of the foot, so that the shoe cover 700 may fit with the preset shoe body at the region corresponding to the tiptoe of the foot, and the upper and the sole may be firmly fixed.

In some embodiments, the connection structure may include an eighth connector 308, a ninth connector 309, and a tenth connector 310. The eighth connector 308 may be connected to the rear side of the left quarter 220, and the fifth connector 305 may be closer to the left quarter 220 than the eighth connector 308. The ninth connector 309 may be connected to the rear side of the right quarter 230, and the sixth connector 306 may be closer to left quarter 220 than the ninth connector 309. The tenth connector 310 may be connected to a rear side of the left side of the left quarter 220, or a rear side of the right side of the right quarter 230. The preset bending process may include that the tenth connector 310 is bent upward. The preset connection relationship may include that the eighth connector 308, the ninth connector 309, and the tenth connector 310 are connected. The eighth connector 308, the ninth connector 309, and the tenth connector 310 may be connected at a region corresponding to the heel of the foot. By setting the eighth connector 308, the ninth connector 309, and the tenth connector 310, and connecting the connection structure according to the preset connection relationship, the shoe cover 700 may fit with the preset shoe body at the region corresponding to the heel of the foot, so that the upper and the sole may be firmly fixed. The connections between the connectors may include buckling, bonding, snapping, or the like.

FIG. 7 is a schematic diagram illustrating an exemplary shoe cover according to some embodiments of the present disclosure. In some embodiments, the planar product of the shoe cover 700 may be printed based on the planar model of the FIG. 3 using the stereolithography printing method. The planar product may be bent according to the preset bending process, and the connection structure of the planar model may be connected according to the preset connection relationship to obtain the shoe cover 700 shown in FIG. 7.

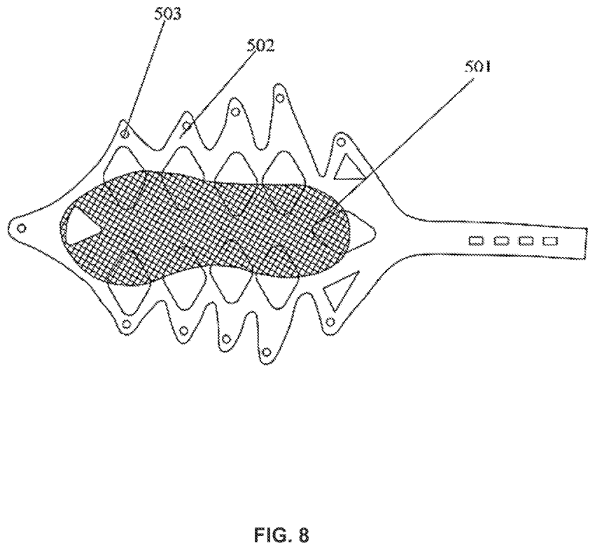

FIG. 8 is a schematic diagram illustrating an exemplary upper of a shoe cover according to some embodiments of the present disclosure. FIG. 9 is a schematic diagram illustrating a whole shoe according to some embodiments of the present disclosure. As shown in FIG. 8 and FIG. 9, the 3D footwear product may include an upper. The connection structure of the upper may include a plurality of connecting holes 503. The plurality of connecting holes 503 may be configured on the upper. The upper may be configured to wrap a pre-made sole 600 to form a whole shoe. In some embodiments, the pre-made sole 600 may be made by 3D printing. In some embodiments, after the upper wraps the pre-made sole 600, the upper may be fixed to the pre-made sole 600 by stitching, or bonding to form the whole shoe.

In some embodiments, the body region 200 of the planar model of the upper may include a bottom 501 and a surface 502 surrounding the bottom 501. The plurality of connecting holes 503 may be configured on the surface 502. In some embodiments, the connecting holes 503 may be configured at one side of the surface 502 away from the bottom 501. In some embodiments, the preset bending process for bending the planar product of the upper may include that bending upward the surface 502 relative to the bottom 501. The preset connection relationship of the connection structure may include that the two sides of the surface 502 relative to the bottom 501 may be connected by passing a strap 504 through the connecting holes 503 and fastening the strap 504. By configuring the connecting holes 503 at one side of the surface 502 away from the bottom 501, after the surface 502 is bent upward relative to the bottom 501, it is convenient to pass the strap 504 through the connecting hole 503 for fastening. In addition, the strap 504 may have a function of a shoelace, which may facilitate a user to adjust the tightness of the fastening.

In some embodiments, the surface 502 may be continuous. In some embodiments, the surface 502 may include a plurality of sub-surfaces. The plurality of sub-surfaces may be sequentially surrounded the bottom 501, and may be connected to the bottom 501. The plurality of sub-surfaces may be arranged at intervals. Each sub-surface may include at least one connecting hole 503. The strap 504 may pass through each connecting hole 503 sequentially to connect the plurality of sub-surfaces.

Another aspect of the present disclosure may provide a 3D footwear product. The 3D footwear product may be manufactured by the methods described in the present disclosure. The 3D footwear product may be a shoe cover, an upper, a sole, a whole shoe, or the like. According to some embodiments of the present disclosure, the manufacturing cost of the 3D footwear product may be reduced. The elasticity requirements and the texture design requirements of the 3D footwear product may be meet. In addition, the 3D footwear product may be designed based on the foot feature data of the user, and the user may wear the 3D footwear product comfortably.

The possible beneficial effects of the method for manufacturing the 3D footwear product disclosed in the present disclosure may include but are not limited to: (1) The planar product may be printed based on the planar model using the 3D printing method, which may simplify the 3D printing process and reduce the difficulty of printing. (2) The planar model of the 3D footwear product may be constructed based on the foot feature data of the user, thereby realizing the customization of the 3D footwear product based on the foot feature data of the user, making the user feel comfortable to wear the 3D footwear product. (3) The stereolithography printing method may be used to print the planar product, the printing speed may be fast and the printing accuracy may be high. (4) The 2D planar model may be exposed and cured layer by layer using the stereolithography printing method, which may make the planar product have a certain texture to meet the requirements of texture design. (5) Elastic materials may be used for printing the planar product, which may facilitate the re-bending of the planar product, and meet the elasticity requirements of the 3D footwear product. It should be noted that different embodiments may have different beneficial effects. In different embodiments, the possible beneficial effects may be any of one or a combination of the above, or any other beneficial effects that may be obtained.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate a certain variation (e.g., ±1%, ±5%, ±10%, or ±20%) of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable. In some embodiments, a classification condition used in classification or determination is provided for illustration purposes and modified according to different situations. For example, a classification condition that “a value is greater than the threshold value” may further include or exclude a condition that “the probability value is equal to the threshold value.”

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for manufacturing a three-dimensional (3D) footwear product, comprising:
obtaining foot feature data, wherein the foot feature data includes a size of a foot;
constructing a planar model of the 3D footwear product based on the foot feature data, wherein the planar model includes a body region and a connection structure connected to the body region; and
printing, based on the planar model, a planar product of the 3D footwear product using a 3D printing method.

2. The method of claim 1, further comprising:
bending the planar product according to a preset bending process; and
connecting the connection structure according to a preset connection relationship.

3. The method of claim 1, wherein the constructing a planar model of the 3D footwear product based on the foot feature data comprises:
constructing a 3D model of the 3D footwear product based on the foot feature data; and
determining the planar model based on the 3D model.

4. The method of claim 3, wherein the planar model includes a hollow region.

5. The method of claim 1, wherein the foot feature data includes at least a length of the foot or a width of the foot.

6. The method of claim 1, wherein the 3D printing method includes at least one of a stereolithography printing method, a fused deposition modeling printing method, or a laser sintering printing method.

7. The method of claim 2, wherein the 3D footwear product is a shoe cover, the shoe cover is used to fit with a preset shoe body to form a whole shoe, and the preset shoe body is pre-made;
wherein the body region of the planar model of the shoe cover includes a vamp, a left quarter, and a right quarter, and the left quarter and the right quarter are both connected to a rear side of the vamp.

8. The method of claim 7, wherein the connection structure includes:
a first connector connected to a left side of the vamp;
a second connector connected to a right side of the vamp;
a third connector connected to a left side of the left quarter; and
a fourth connector connected to a right side of the right quarter.

9. The method of claim 8, wherein:
the preset bending process includes:
bending down a region of the planar product corresponding to the left quarter, and a region of the planar product corresponding to the right quarter, relative to a region of the planar product corresponding to the vamp;
bending down a left side of the region of the planar product corresponding to the vamp;
bending down a right side of the region of the planar product corresponding to the vamp;
bending a left side of the region of the planar product corresponding to the left quarter to the right; and
bending a right side of the region of the planar product corresponding to the right quarter to the left; and
the preset connection relationship includes:
the first connector being connected to the second connector, and the third connector being connected to the fourth connector.

10. The method of claim 8, wherein a connection process of at least one of the first connector, the second connector, the third connector, or the fourth connector includes at least one of buckling, bonding, or snapping.

11. The method of claim 2, wherein the 3D footwear product includes an upper, the connection structure includes a plurality of connecting holes, the plurality of connecting holes are configured to be located on the upper, and the upper is configured to wrap a pre-made sole to form a whole shoe.

12. A three-dimensional (3D) footwear product, wherein the 3D footwear product is manufactured according to a process including:
obtaining foot feature data, wherein the foot feature data includes a size of a foot;
constructing a planar model of the 3D footwear product based on the foot feature data, wherein the planar model includes a body region, and a connection structure connected to the body region; and
printing, based on the planar model, a planar product of the 3D footwear product using a 3D printing method.

13. The 3D footwear product of claim 12, wherein the process further comprising:
bending the planar product according to a preset bending process; and
connecting the connection structure according to a preset connection relationship.

14. The 3D footwear product of claim 12, wherein the constructing a planar model of the 3D footwear product based on the foot feature data comprises:
constructing a 3D model of the 3D footwear product based on the foot feature data; and
determining the planar model based on the 3D model.

15. The 3D footwear product of claim 14, wherein the planar model includes a hollow region.

16. The 3D footwear product of claim 12, wherein the foot feature data includes at least a length of the foot or a width of the foot.

17. The 3D footwear product of claim 12, wherein the 3D printing method includes at least one of a stereolithography printing method, a fused deposition modeling printing method, or a laser sintering printing method.

18. The 3D footwear product of claim 13, wherein the 3D footwear product is a shoe cover, the shoe cover is used to fit with a preset shoe body to form a whole shoe, and the preset shoe body is pre-made;
wherein the body region of the planar model of the shoe cover includes a vamp, a left quarter, and a right quarter, and the left quarter and the right quarter are both connected to a rear side of the vamp.

19. The 3D footwear product of claim 18, wherein the connection structure includes:
a first connector connected to a left side of the vamp;
a second connector connected to a right side of the vamp;
a third connector connected to a left side of the left quarter; and
a fourth connector connected to a right side of the right quarter.

20. The 3D footwear product of claim 19, wherein:
the preset bending process includes:
bending down a region of the planar product corresponding to the left quarter, and a region of the planar product corresponding to the right quarter, relative to a region of the planar product corresponding to the vamp;
bending down a left side of the region of the planar product corresponding to the vamp;
bending down a right side of the region of the planar product corresponding to the vamp;
bending a left side of the region of the planar product corresponding to the left quarter to the right; and
bending a right side of the region of the planar product corresponding to the right quarter to the left; and
the preset connection relationship includes:
the first connector being connected to the second connector, and the third connector being connected to the fourth connector.
